(19) United States
(12) Patent Application Publication
(10) Pub. No.: US 2019/0295194 A1
(43) Pub. Date: Sep. 26, 2019

(54) NON-FIXED FUEL PLATFORM THAT CAN ACCEPT AUTOMATIC PAYMENT FOR FUEL DISPENSED

(71) Applicant: Robinson Metal, Inc., De Pere, WI (US)

(72) Inventors: KEITH KARL KITTOE, GREEN BAY, WI (US); JESSE RYAN NELSON, DE PERE, WI (US)

(73) Assignee: Robinson Metal, Inc., De Pere, WI (US)

(21) Appl. No.: 16/441,480

(22) Filed: Jun. 14, 2019

Related U.S. Application Data
(63) Continuation-in-part of application No. 15/213,400, filed on Jul. 19, 2016.
(60) Provisional application No. 62/193,426, filed on Jul. 16, 2015.

(51) Int. Cl. G06Q 50/06; G06Q 20/20; G06Q 20/32

(52) U.S. Cl. CPC G06Q 50/06; G06Q 20/202; B60P 3/225; G06Q 20/3278; G06Q 20/204

(57) ABSTRACT

A portable system for transporting, storing, and dispensing liquid fuel. The portable system includes two or more non-manifolded fuel tanks and a pump dispensing system consisting of a fuel pump, a fuel hose, and a nozzle. The portable system further includes a portable platform consisting of a frame sufficient to support the weight of the entire system while the two or more non-manifolded fuel tanks are full of the liquid fuel. The portable system further includes a custody transfer flow meter and a point of sale system.

### CROSS REFERENCE TO RELATED APPLICATIONS

This application is a continuation-in-part of U.S. patent application Ser. No. 15/213,400, filed Jul. 19, 2016, which claims priority to U.S. Provisional Patent Application No. 62/193,426 filed Jul. 16, 2015, which are incorporated herein by reference in their entirety.

### FIELD

The present invention relates to a non-fixed fuel platform that can accept automatic payment for fuel dispensed.

### BACKGROUND

Currently, there is a need for a non-fixed or mobile fuel platform which can dispense relatively small quantities for a liquid fuel, for example 100 gallons or less at a time. The liquid fuel can include but not limited to various octane levels of gasoline, kerosene, diesel fuel, marine fuel and aviation fuel. Many establishments that sell fuel, such as marinas, airports, landing strips, resorts, convenience stores, and off-road establishments are open only during regular business hours, for example, 7 a.m. till 11 p.m. No person is around after hours to dispense fuel to potential customers. Such customers can arrive by car, van, truck, motorcycle, snowmobile, an all-terrain vehicle (ATV), boat, jet ski, airplane, helicopter, or seaplane. The customer is willing to pump the fuel themselves (self-serve) and would like to be able to pay using some kind of an automatic payment method, such as, credit card or pre-existing customer account with the merchant. The automatic payment method could include but is not limited to: cash, a credit card, a debit card, a fleet card, a gift card, a pin number pre-registered to an established bank account, or by some other automatic payment method known to those skilled in the art.

In addition, some airports have a few different types or grades of fuel available but can't afford to inventory all of the various octane level fuels or types that may be requested by their customers. For example, Mogas is a gasoline derivative of lower octane content than typical aviation gas, known as Avgas 100LL. While Mogas and other non-100LL alternatives continue to come to market typically for use in small single engine piston propeller airplanes, these new fuel types are not available to average consumers that need it for their airplanes because it is not economical for an airport to purchase and install a large permanent fuel station to provide these low volume use fuel types when compared to their regularly supplied 100LL. Furthermore, some airports have both a land based airstrip and a water landing area to accommodate seaplanes. However, all of their fuel storage tanks are located adjacent to the land based airstrip. This means that when a seaplane needs to be refueled, fuel has to be manually transported down to the water where the seaplane is docked as oppose to being able to provide a non-fixed platform such as a fuel trailer that can be better positioned next to where the fuel dispensing is needed. These examples are common and where the present invention is able to provide an immediate solution.

Examples of prior art that are the typical fixed and non-mobile fuel platforms that can accept different payment methods can be found at these websites:

http://www.gasboy.com/us/products/commercial-fleet-dispensers

http://www.myfuelmaster.com/products/details/fuelmaster_3505_plus

http://www.bennettpump.com/

http://www.ezfuel.com/ast_fuel_systems/

Today, in many locations, the owner of an automobile can drive up to a gas station and get fuel twenty-four hours a day by inserting a credit or debit card into a fuel dispensing mechanism. It would be nice if the owners of boats, jet skies, airplanes, helicopters, snowmobiles, or all-terrain vehicles (ATV) could do the same, especially in remote areas.

Now, a non-fixed or mobile fuel platform has been invented which will allow one or more different types or grades of fuel to be dispensed at any time using an automatic payment method. The non-fixed or mobile platform is designed to be moved to various locations depending on demand. The non-fixed or mobile platform can be self-serve or operator attended.

Similar to the self-serve non-fixed fuel dispensing platforms, automated payments can also be taken or received by merchants who prefer to operate and dispense fuel as an attendant delivered solution where they provide a mobile fuel delivery service to their customers. This method allows businesses to service their customers at remote distant locations by an employee or operator of the fuel delivery company. Without this type of service made possible by the present invention, consumers are required to drive or fly to a central fuel filling station.

### SUMMARY

Briefly, this invention relates to a non-fixed fuel platform that can accept automatic payment for fuel dispensed. In a preferred embodiment, a non-fixed fuel platform may include a trailer having a frame and a set of wheels secured to the frame. A draw bar extends out from the frame and includes a towing adapter. The trailer supports one or more fuel tanks, a first compartment area which houses components of the pump dispensing system such as the fuel hose reel and nozzle; a second compartment which house a custody transfer flow meter that meets the requirements of “Weights and Measures” accuracy approval for fuel sales; and a third compartment which houses a point of sale system known in the art to include electronic devices such as payment acceptance readers, display and button interfaces, networking equipment, and remote payment processor connection mechanisms. The non-fixed fuel platform permits a person to self-dispense fuel by paying for the fuel with a credit card or some other form of payment.

In a second preferred embodiment, a non-fixed fuel platform may include a vehicle or surface-mount platform skid having a frame and portable method of moving it, such as fork pockets to be picked up and moved by a forklift or hook anchor points to be lifted by a crane or similar equipment. The skid's platform supports the same pump dispensing system, custody transfer flow meter, and point of sale system as the trailer preferred embodiment.

Fuel dispensing to end user consumers on the preferred non-fixed mobile embodiments are accomplished by two primary methods. These methods include self-serve fueling where the consumer dispenses their own fuel into their vehicle or equipment or attendant fueling where an operator dispenses the fuel into the consumer or other type of customer vehicle or equipment. Upon completion of both of these fueling methods, an automatic payment occurs by charging the consumer or customer credit card, billing account, receiving cash, or other automatic occurring payment type.

The practical ability of the present invention to fuel small vehicles and systems are numerous; for example, site generators, farm equipment, construction equipment, and aircraft. The present invention allows fueling without moving the vehicle to the fuel station. This mobility is a large component of what these mobile fuel stations provide to the market. Integrating Point of Sale functionality, contract management, and time-shifted billing methods into the same mobile system allows for the operators to provide the full services of a stationary fueling system while being able to service users at their location of choice.

Market efficiency is gained by the present invention by shifting the time, work, and energy of moving the users of the fuel, to moving the fuel to the users in the same way delivery drivers of any good can be more efficient on a route than individuals having to make individual independent trips.

In a preferred embodiment, sensors on the system allow for management by the on site operators as well as remote monitoring, payment system integration, and transaction reporting.

The general object of this invention is to provide a non-fixed or mobile fuel platform that can accept automatic payment for fuel dispensed. A more specific object of this invention is to provide a non-fixed fuel platform that can be positioned in a remote location where fuel is occasionally needed but no attendant is present.

Another object of this invention is to provide a non-fixed fuel platform that can be used at an airport or a marina to store a certain grade of liquid fuel that is not in great demand.

A further object of this invention is to provide a non-fixed fuel platform that can dispense fuel 24 hours a day, 7 days a week, even when no attendant is available.

Still further, an object of this invention is to provide a non-fixed fuel platform that can be moved from one location to another location.

Still another object of this invention is to provide a non-fixed fuel platform which will accept various forms of payment for the fuel dispensed.

One embodiment of the present disclosure generally relates to a portable system for transporting, storing, and dispensing liquid fuel. The portable system includes two or more non-manifolded fuel tanks and a pump dispensing system consisting of a fuel pump, a fuel hose, and a nozzle. The portable system further includes a portable platform consisting of a frame sufficient to support the weight of the entire system while the two or more non-manifolded fuel tanks are full of the liquid fuel. The portable system further includes a custody transfer flow meter and a point of sale system.

Another embodiment generally relates to a system for managing the sale of liquid fuel. The system includes one or more portable systems for transporting, storing, and dispensing the liquid fuel. Each of the one or more portable systems includes two or more non-manifolded fuel tanks, and a pump dispensing system consisting of a fuel pump, a fuel hose, and a nozzle. Each of the one or more portable systems further includes a portable platform consisting of a frame sufficient to support the weight of the entire system while the two or more non-manifolded fuel tanks are full of the liquid fuel, a custody transfer flow meter, a wireless communication device, and a point of sale system. The system further includes a cloud-based server configured to communicate with the one or more portable systems via the wireless communication device, where the cloud-based server is configured to receive data regarding purchases of the liquid fuel made via the point of sale systems for each of the one or more portable systems.

Other objects and advantages of the present invention will become more apparent to those skilled in the art in view of the following description and the accompanying drawings.

### BRIEF DESCRIPTION OF THE DRAWINGS

FIG. 1 is a perspective view showing the rear and driver sides of a non-fixed fuel platform that can accept automatic payment for fuel dispensed; and

FIG. 2 is a rear view which depicts the present invention in a self-serve dispensing configuration on a trailer as the mobile transportation platform; and

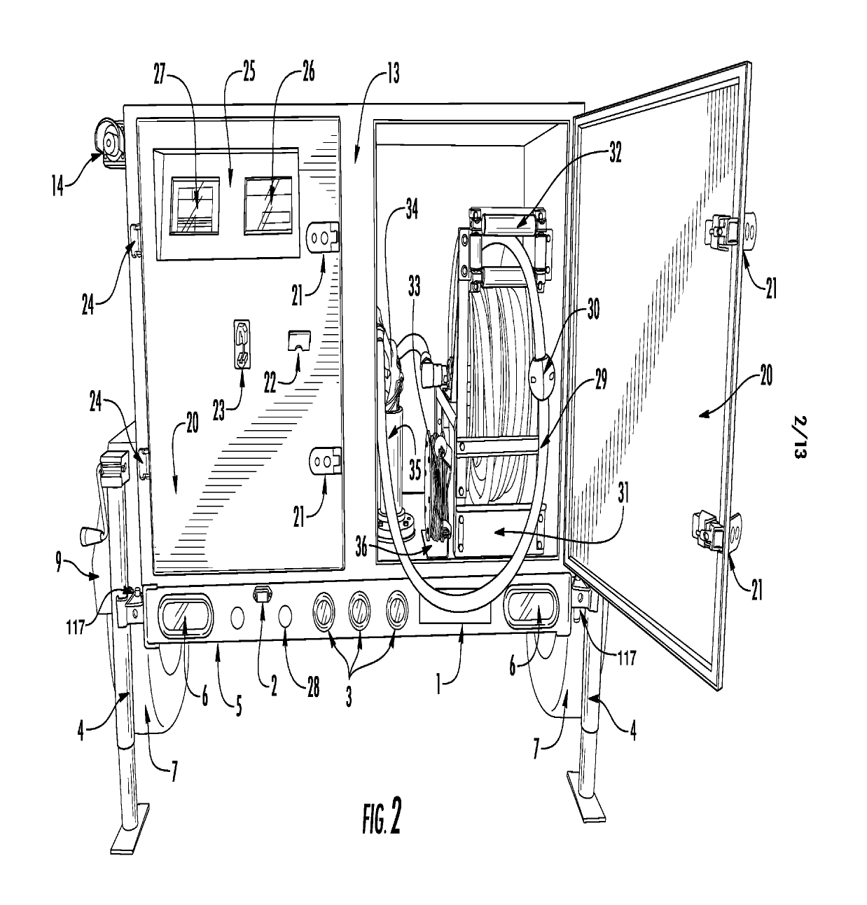

FIG. 3 is a close-up view which depicts the display screen of a preferred embodiment consisting of a custody transfer electronic register and its computerized sensor, monitoring, and other analog and digital equipment readings and values; and

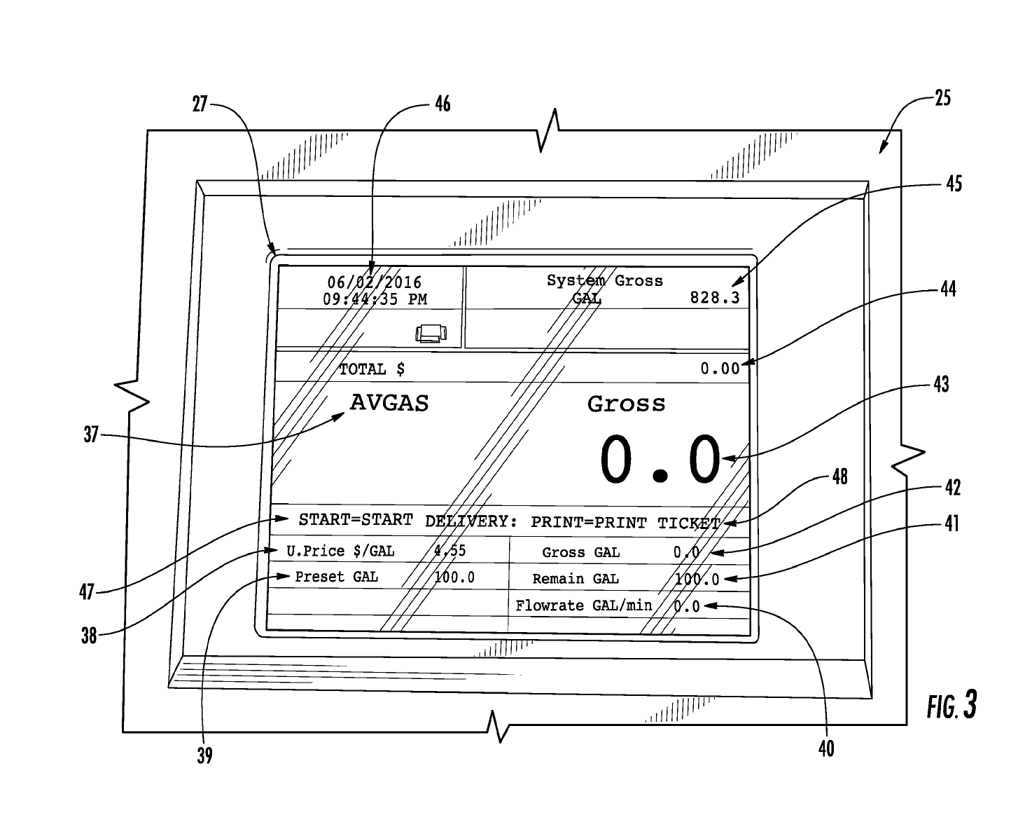

FIG. 4 is a close-up view which depicts the display screen of a preferred embodiment consisting of a touch screen monitor, kiosk interface elements, fuel types and pricing available in a self-serve configuration that can receive automatic payment for what is shown and offered for sale, as well as the automatic payment method types accepted at the self-serve fuel dispensing system shown; and

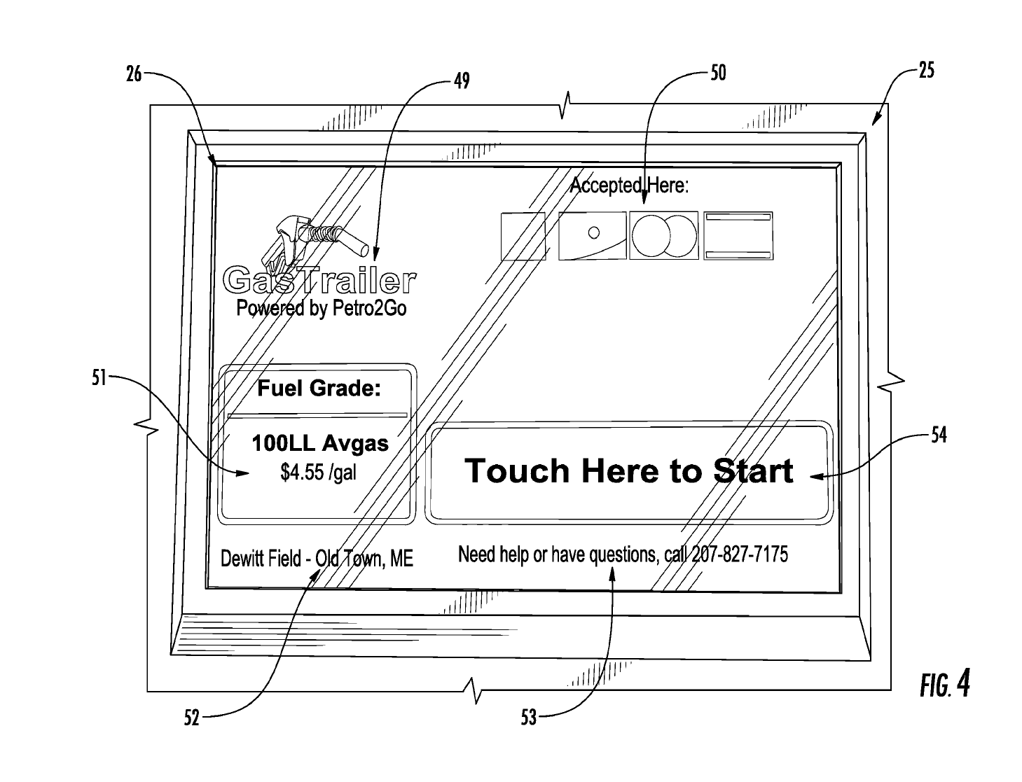

FIG. 5 is a rear perspective view of a fuel trailer with a preferred embodiment that includes a point of sale system in the left driver side compartment with supporting electronic devices and a custody transfer electronic register, whereas, the right passenger side compartment depicts a pump dispensing system with an included fuel hose reel, nozzle, and grounding cable reel; and

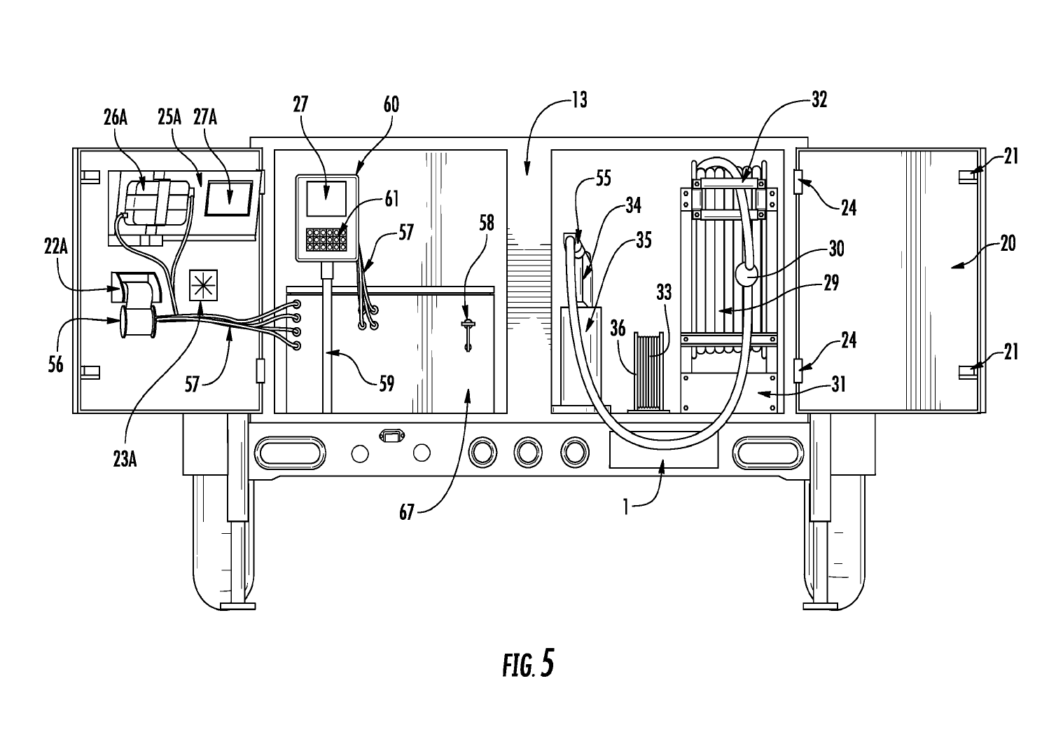

FIG. 6 is a perspective view showing a custody transfer electronic register with a preferred embodiment that includes a push button interface for computerized control of fuel dispensing transactions; and

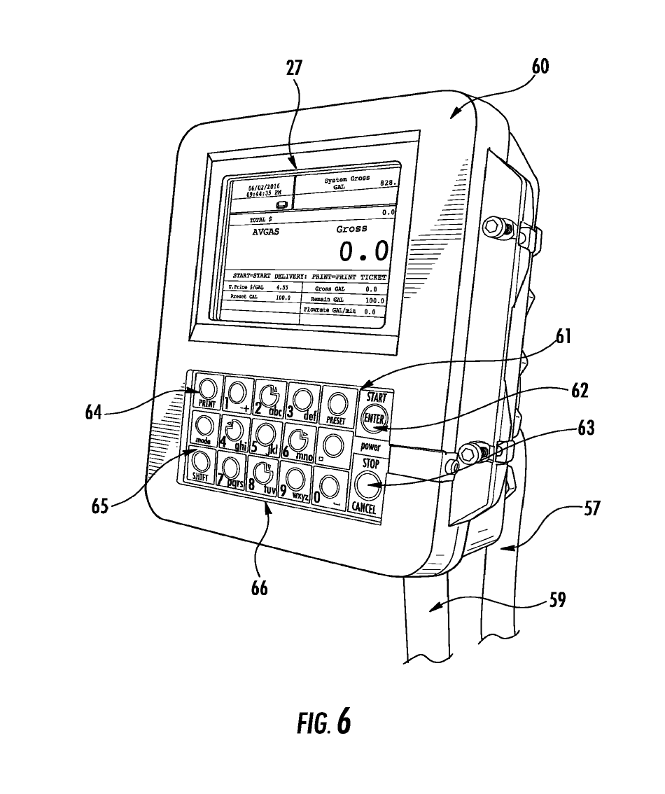

FIG. 7 is an overview perspective of a preferred embodiment consisting of the primary electronic components, devices, and controllers that provide the different analog, digital, serial, wireless, Ethernet, and other types of network communication which as a whole, makeup the logical circuitry to control the point of sale system functionality; and

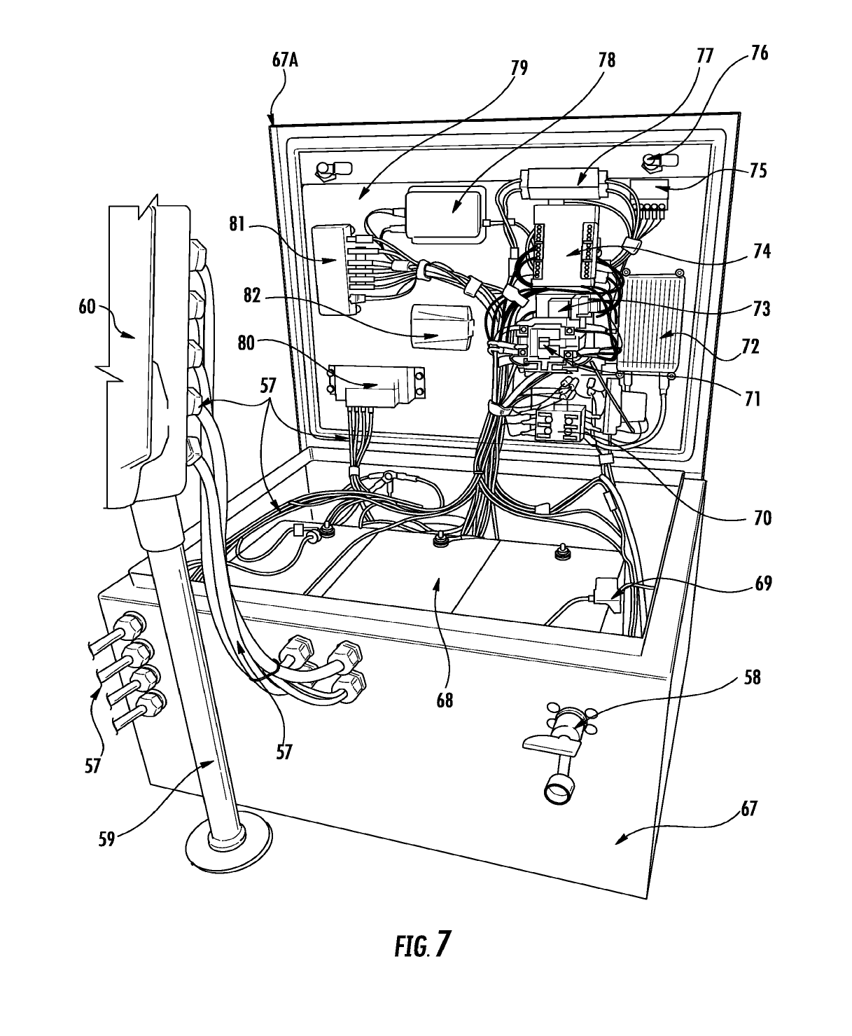

FIG. 8 is a front perspective view showing some of the present invention's primary pump dispensing system which includes a custody transfer flow meter, fuel filter, pump, valves, and gauges housed inside of a separate compartment on the non-fixed platform; and

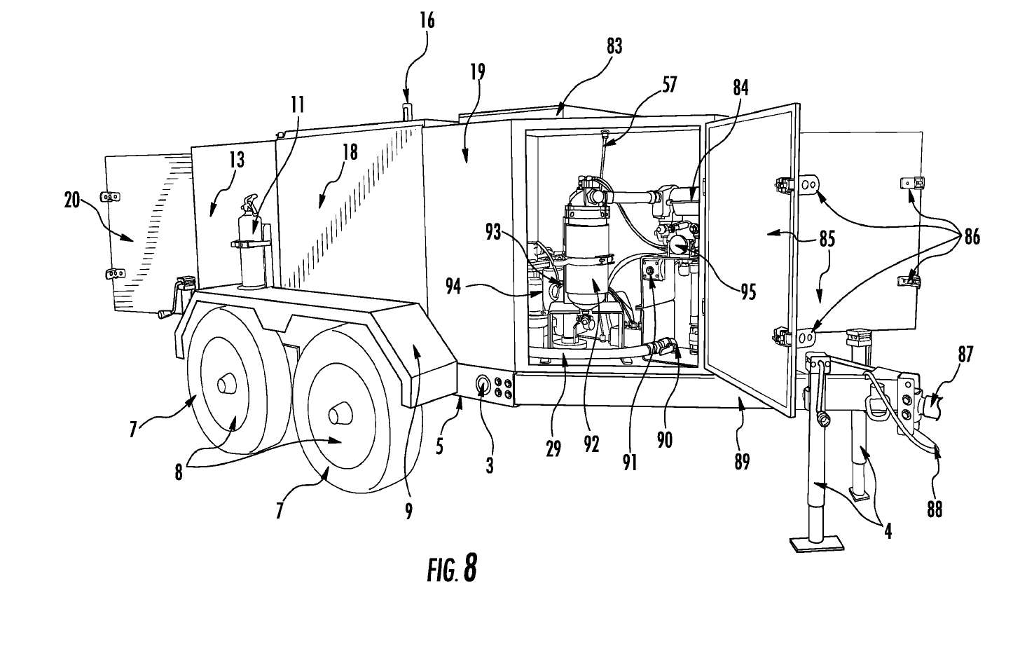

FIG. 9 is an internal compartment view of some of the primary pump dispensing system components which include the pump, filter, gauge, pressure relief valves, fuel hose, and fittings; and

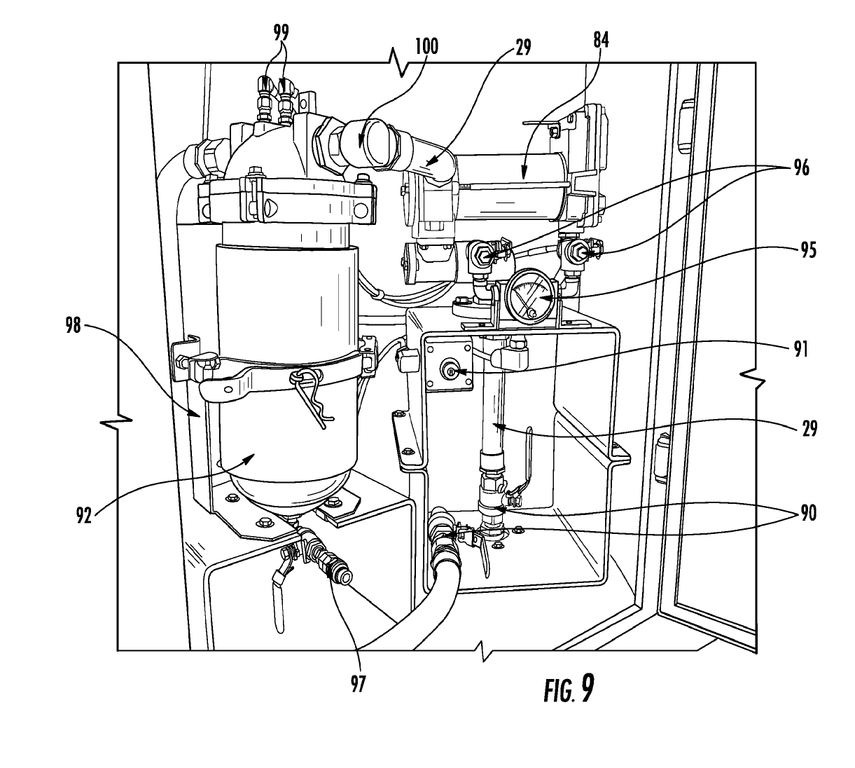

FIG. 10 is another internal compartment view of some of the primary pump dispensing system components which include the custody transfer flow meter, preset delivery solenoid control valves, air eliminator exhaust tank, and remote mount electronic signal pulser; and

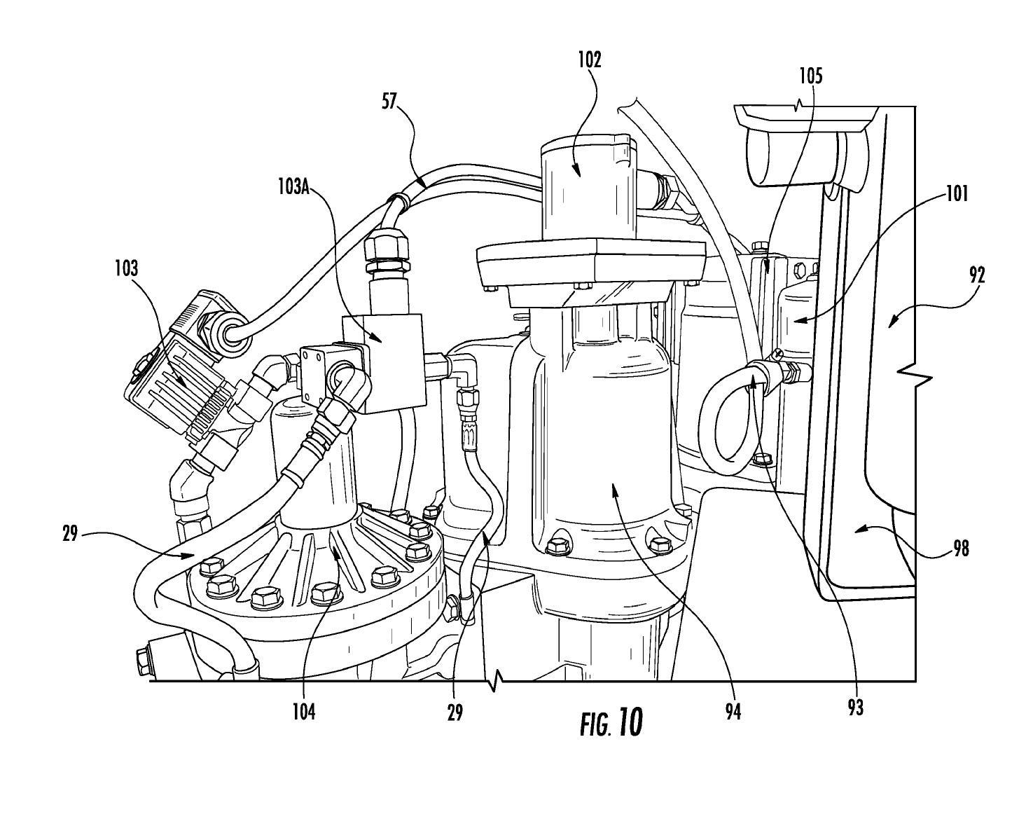

FIG. 11 is a close-up view of a non-fixed platform trailer drawbar with a quick connect solar panel adapter and sump drain discharge port; and

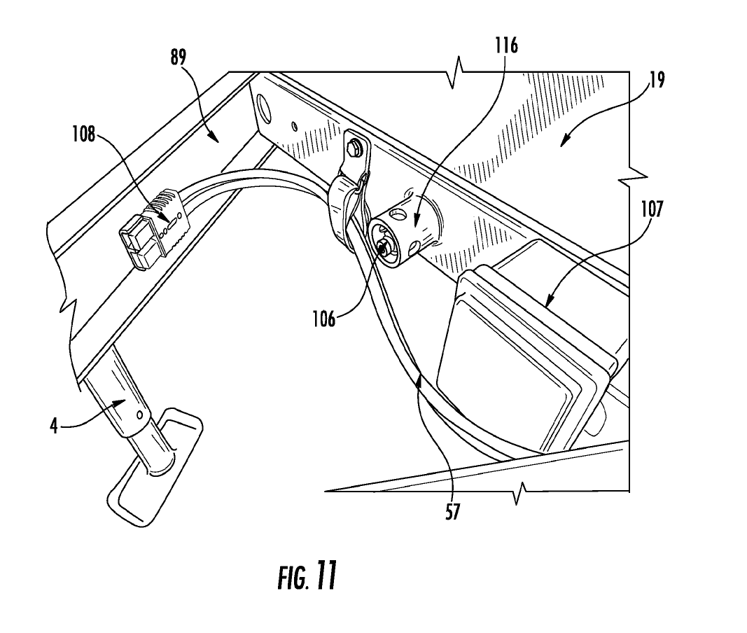

FIG. 12 is a top perspective view showing the present invention with preferred embodiments including an enclosure compartment, solar panel, tank level gauges, fill cap, and wireless internal and external network antenna; and

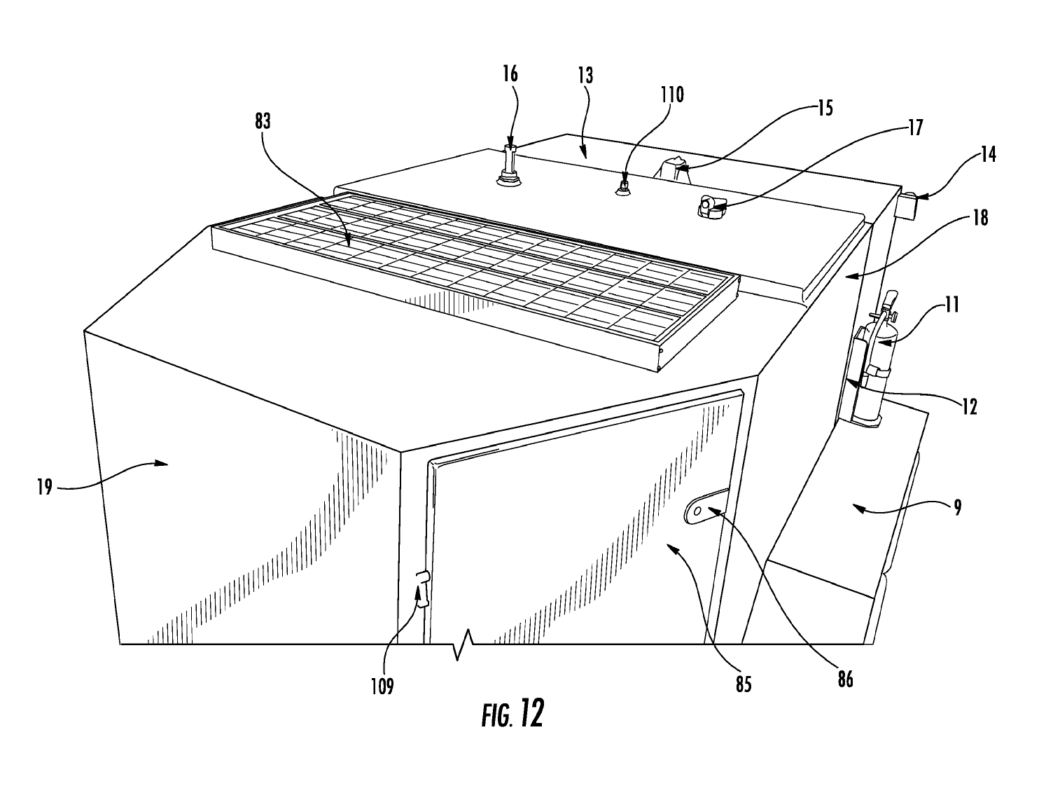

FIG. 13 is a close-up view of a tank discharge fuel line that depicts an installed electronic ball valve, quick release cam lock fittings, and a sump drain discharge outlet; and

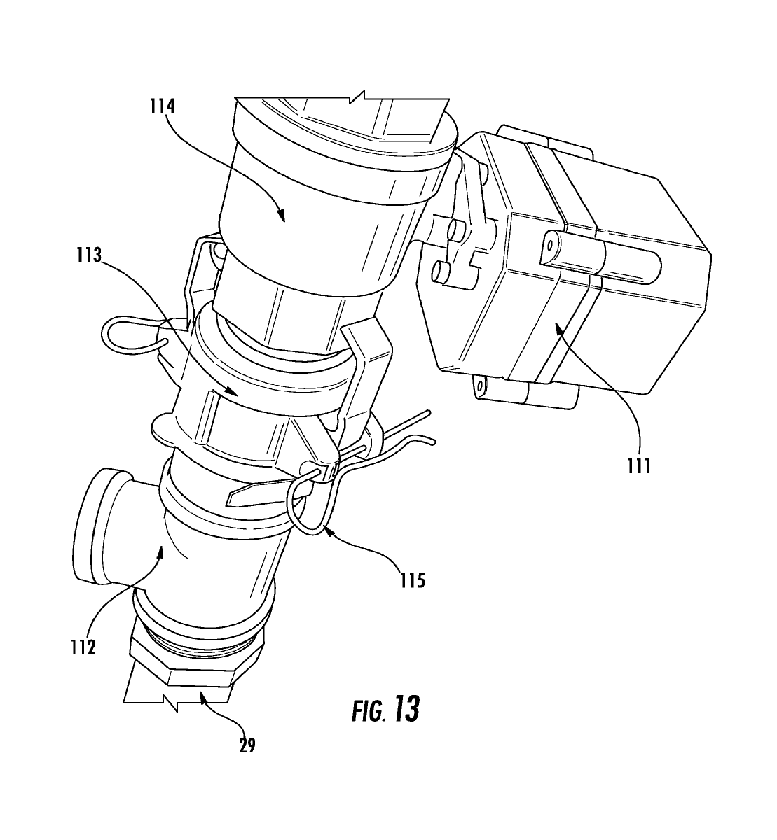

FIG. 14 is a schematic of an exemplary control system for controlling the non-fixed fuel platform.

### DETAILED DISCLOSURE

There are several primary components that makeup a trailer as it relates to a trailer being used as a non-fixed mobile platform. This includes the frame 5 that all other items are installed on or off of. The frame is commonly mounted to a set of axles for its suspension that has tires 7 and wheels 8 attached to the end of the axles. The tires are what contact the surface of the ground when the non-fixed platform is being transported and the wheels are what the tires are mounted around for movement. As the wheels spin, the platform is able to be pulled and towed on-road and off-road.

During towing and transportation, the other items of the trailer that contribute to its overall platform are the fenders 9 that prevent water, rocks, or other debris from elevating off the surface that could otherwise create unsafe driving conditions. To help with safety and allow others to know the width of a trailer at a quick glance, side fender marker lights can be installed to display the widest points of the trailer. In addition to the side fender marker lights, there are also rear marker lights 3 to indicate the center point area of the frame another visual reference. Also installed on most trailers are rear tail, turn, and brake lights 6 to alert anyone driving behind the trailer when it is braking to slow down, turn, or to enhance the trailer's visibility. This is also the case with installed license plate lights 2 for visibility and trailer identification. The license plate light or lights are commonly installed above or on the side of where the license plate is mounted to the frame of the trailer through license plate mounting holes 28. Not always installed, but many trailers will have some type of name badge 1, logo, or plate to identify the type and brand of the trailer.

In order to tow a trailer, the trailer coupler 87 needs to attach to the tow vehicle. The wire harness adapter will also need to attach to the tow vehicle to provide power to the marker lights and tail, turn, and brake lights installed around the trailer frame. A wire harness adapter 88 is most commonly either a 4-pin flat adapter or a 7-pin round adapter. The front of the trailer that the harness usually runs through and the coupler is attached to is the drawbar. The drawbar 89 can sometimes be considered part of the frame, but it is commonly identified separately since other items known in the art are mounted to the drawbar. This includes the safety chain breakaway system 107 and safety chains that attach to the tow vehicle to keep the trailer connected in the event that the coupler were to detach from the tow vehicle while transporting it. When stationary, there is usually a jack pipe mount 116 to attach a stabilizer jack to the drawbar or frame as a leg to lift the trailer off the vehicle's ball adapter as a common adapter type. Standard with pipe mount jacks and other types is a jack pipe mount locking pin 117 or similar lock to keep the jack attached to the pipe mount when the jack is attached.

The tank 18 is the primary container that houses the liquid fuel. On top of the tank are the access ports such as the fill cap. This is removed to then insert a fuel nozzle 34 into the tank to fill it up. Some fill caps are press-release types and other are lockable fill caps 17 secured with a key or padlock. It is common in the art to install pressure relief valves or rollover exhaust valves 110 onto the tops of tanks to allow fumes to escape when pressure builds up. Likewise, when fuel is being discharged out of the tank, a negative pressure situation will occur inside the tank and a vacuum effect can occur. With a rollover exhaust valve installed, air can enter into the tank to prevent this effect from occurring, otherwise known as allowing the tank to breathing. When filling up the tank or discharging fuel from it, a tank level gauge 16 installed on the top of the tank can be a good way to know approximately how much fuel is remaining in the tank. This way, you can fill up with low or make sure not to overfill when filling up.

Different types of enclosures are common in the art as a way to compartmentalize fuel components such as pump dispensing systems, custody transfer flow meters 94, hose reels and nozzles, or other fueling items to isolate and separate them from point of sale electronic components. Since a tank is not usually positioned all the way to the rear of a trailer platform or mobile skid unit for stability when towing or transporting, a rear enclosure 13 is commonly installed as a way to provide easy access to fuel hose reels 31, electronic component enclosures, or other items inside of them. A rear enclosure will usually have rear enclosure doors 20 and rear enclosure door locking handles 21 to allow the internal items to be secured and locked away if needed. The rear enclosure doors pivot and swing on the rear enclosure door hinges 24 for smooth opening and closing.

For easy access to point of sale system components, holes and opening can be cut out or fabricated from enclosure doors and panels. This allows for kiosk display panels 25 to be seen from the outside of the enclosure. With either rear enclosures or front enclosure 19 configurations, when the front enclosure door 85 is open and swinging around the front enclosure door hinge 109, the kiosk display panel rear housing 25A can be seen if installed on that door. The front enclosure door locking handles 86 would also be exposed when the front enclosure door is open. Another display panel on a non-fixed automatic payment platform would be a display window for a custody transfer electronic register 27A to see through the door and know how a fueling transaction progress is going.

To house electronic components inside or outside of front or rear enclosures, electronic component enclosures 67 are known in the art. The electronic compartment enclosures would have an electronic component lid 67A installed on them to securely seal the enclosure and those usually have electronic component enclosure locking latches 76 to lock them up for safety and prevent electronics from being exposed to outside elements.

Fuel dispensing systems on non-fixed platforms that accept automatic payments consist of many different components to allow fuel to be dispensed, sold, refilled, and more. Safety is an important factor when handling fuel hose 29 and turning on fuel pumps 84 to discharge out of the fuel nozzle 34. To help prevent static spark discharge during the fueling process, a grounding cable reel 36 with grounding cable 33 should be installed to attach the non-fixed platform frame to the vehicle or equipment that fuel is being dispensed into. In addition, fire extinguishers 11 can be installed using a fire extinguisher mounting bracket 12 so they are on-hand in the event of a possible fire.

When fuel hose is being retracted from a hose reel, it commonly will be aligned inside of fuel hose reel roller guides 32 to keep the fuel hose from kinking. When the fuel hose is being retracted back into the reel, a fuel hose ball stopper 30 will prevent it from being retracted to far and slip inside the roller guides that would make it difficult for the next time it is used. The fuel nozzle at the end of the fuel hose reel is usually stored in a fuel nozzle holder bracket 35 when not in use. To make it easier for the nozzle to be inserted and removed from the fuel nozzle holder bracket, a multi-directional nozzle swivel 55 can be installed to help with this process.

The following are the other primary pump dispensing system components known in the art to be used on different types of fuel system platforms:

90: Fuel Flow Control Valve 91: Sump Drain Valve Bypass Switch 92: Fuel Filter Housing 93: Air Eliminator Exhaust Tank 95: Differential Pressure Gauge 96: Pressure Control Valves 97: Filter Sump Drain Discharge Port 98: Filter Housing Mounting Bracket 99: Differential Pressure Gauge Supply Lines 100: Swivel Elbow Fitting 101: Air Eliminator Float Switch Sensor 102: Remote Mount Signal Pulser 103: Preset Delivery Solenoid Control Valve 1 103A: Preset Delivery Solenoid Control Valve 2 104: Diaphragm Preset Valve 105: Air Eliminator Separator 106: Sump Drain Discharge Port 111: Electric Ball Valve Actuator 112: Sump Drain Discharge Outlet 113: Quick Release Cam Lock Coupler 114: Electric Ball Valve 115: Quick Release Cam Lock Pin

The point of sale system is a complex computerized payment processing system that has preferred embodiments consisting of the following primary components:

14: Emergency Stop Button 15: Wireless Internal and External Network Antenna 22: Receipt Printer 22A: Receipt Printer Rear 23: Card Payment Reader 23A: Card Payment Reader Rear 26: Touch Screen Display Interface 26A: Touch Screen Display Interface Rear 27: Custody Transfer Electronic Register 37: Fuel Type Indicator 38: Unit Price Indicator 39: Preset Capacity Indicator 40: Flow Rate Indicator 41: Remaining Capacity Indicator 42: Gross Capacity Indicator 43: Gross Capacity Primary Indicator 44: Total Price Indicator 45: System Gross Indicator 46: Date and Time Indicator 47: Delivery Status Indicator 48: Receipt Ticket Status Indicator 49: Logo 50: Payment Methods Accepted Indicator 51: Fuel Type and Price Indicator 52: Location Indicator 53: Message Prompt Indicator 54: Begin Transaction Indicator 56: Receipt Paper Roll 57: Cable Harness Wiring and Connectors 58: Power Disconnect Switch 59: Custody Transfer Electronic Register Stand 60: Custody Transfer Electronic Register 61: Push Button Keypad Interface 62: Start Button 63: Stop Button 64: Print Button 65: Shift Button 66: Push Button Navigation Keys 68: Battery 69: Fuse Holder 70: Fused Distribution Block 71: Contactor Relay 72: Computer Power Supply 73: Double Pull Double Throw Switch 74: Analog and Digital Input and Output Signal Controller 75: Step Down Voltage Converter 77: Step Up Voltage Controller 78: Mobile Broadband Cellular Modem Router 79: Electronic Component Mounting Plate 80: Solar Power Charge Controller 81: Local Area Network Wired Gateway 82: Local Area Network Wireless Gateway 83: Solar Panel 108: Quick Connect Solar Panel Adapter

A non-fixed or mobile fuel platform can accept an automatic payment for fuel dispensed. One non-fixed or mobile fuel platform includes a trailer. The trailer has a frame that can vary in size, shape and construction. Attached to the frame is a set of wheels. By “wheel” it is meant a solid disk or a rigid circular frame, designed to turn around a central axis. On the outside of the wheel for traction and driving control, a tire usually made of rubber material, is secured to the wheel for smooth transporting of the trailer. It should be understood that as the size of the trailer increases, the number of sets of wheels can also increase to handle the load. The set of wheels can vary in size and design. Fifteen and sixteen inch wheels are commonly employed on the trailer. Each wheel can be constructed out of a strong material, such as aluminum, polished aluminum, steel, etc. Each wheel also includes a tire. By “tire” it is meant a covering for a wheel, usually made of rubber reinforced with cords of nylon, fiberglass, or other material and filled with compressed air. The tires can be radial tires, bias ply tires or any other kind of a tire commercially available and known to those skilled in the art.

It should be understood that the non-fixed or mobile fuel platform is designed to be moved from one location to another location as demand dictates. However, it is also possible to position the non-fixed or mobile fuel platform in a single location and leave it there. Generally, the non-fixed or mobile fuel platform is designed to have at least one set of wheels so that it can be moved about. However, an alternative embodiment of the non-fixed or mobile fuel platform does not use a set of wheels but instead is a stationary platform that can be lifted, moved or be transported by an external device, such as a fork lift truck, a crane, etc. when needed. The stationary platform could be mounted on a conventional trailer, in the bed of a pickup truck, on a barge, etc.

The trailer can be formed from various materials. Desirably, the trailer is constructed out of metal, a metal alloy, steel, a steel alloy, aluminum, etc. The trailer could be powder coated, painted or be treated in some fashion, known to those skilled in the art, to prevent rust and/or corrosion. The various members constituting the frame of the trailer can be welded together or be secured using standard hardware such as bolts, washers, lock washers and nuts. The trailer also includes a draw bar or tongue secured to the front of the frame. A towing adapter can be secured to the draw bar or tongue. The towing adapter can vary in size, shape and design. The towing adapter can contain a wiring harness. The wiring adapter can include a 4 or 7 pins connector. An adjustable height device can also be secured to the front of the draw bar or tongue so as to allow one to adjust the height of the draw bar or tongue. This is needed to facilitate attachment of the draw bar or tongue to a hitch secured to a towing vehicle. A coupler is secured to the front end of the draw bar or tongue to allow the trailer to be towed behind a motorized vehicle, such as a car, van, truck, etc. The coupler can vary in size, shape and design. The coupler can be a ball coupler, a pintle ring, a bulldog, a clevis or some other style of coupler known to those skilled in the art. The trailer also includes a single or tandem torsion axle (not shown) on which the set of wheels are attached. The trailer can also include electric or hydraulic brakes (not shown). The brakes can include various brake components, such as brake pads, rotors, pistons, etc. which are well known to those skilled in the art. The brakes can also include a breakaway kit having one or more controllers, a sensor pin, a battery and a charger. On a breakaway kit, when the sensor pin is removed, the brakes will engage. This action can also function as a parking brake.

The one or more set of wheels can be secured to the axle by lug nuts. The lug nuts can be hardened for needed strength. The lug nuts can be formed from stainless steel or be chrome plated. The trailer can further include removable pipe-mount jack(s), weld-on jacks, or bolt-on swivel jacks (not shown). The jacks are used to balance and support the trailer when it is stationary. Lastly, the trailer can contain one or more lights. The lights can be LED lights. The trailer may include tail lights, turn signals, brake lights, market lights, side market lights, fender marker lights, rear center indicator lights, license plate light, and interior lights on control compartments and enclosures. When the non-fixed or mobile fuel platform (alternative embodiment) is a skid mounted platform, it can include a steel pallet-style platform with fork truck loadable channels. The skid mounted platform can be mounted onto the deck of the trailer, in the bed of a truck or vehicle, on a ground surface or platform, on a barge, etc. This provides the skid mounted platform to be used with a trailer or as a stand-alone platform that the tanks, pumps, and fueling components are mounted to. The skid mounted platform can contain mounting brackets to enable it to be bolted down to the surface of a trailer, vehicle, or platform. The mounting brackets will allow the skid mounted platform to be anchored in place. Removable push-button pins or lock pins can be used to anchor and attach the skid mounted platform to the mounting brackets.

Still referring to the non-fixed or mobile fuel platform also includes one or more fuel tanks. The fuel tanks can vary in size, shape, construction, and materials from which it is constructed. The fuel tanks could be made from carbon steel, aluminum, stainless steel, a metal alloy, a steel alloy, a composite material, a fiberglass reinforced material or any other strong and durable material known to those skilled in the art. The fuel tanks can be of a single or double wall design. The double wall design provides an extra layer of containment against leaks or spills should the internal tank crack or if the outer tank is punctured or fractured. A double wall interior tank is essentially a tank inside of a tank to contain 110% or more of the total fuel capacity. The fuel tank can be a single tank. Alternatively, two or more tanks can be mounted on the non-fixed or mobile fuel platform 10. When two fuel tanks and are utilized, one fuel tank can contain one kind of fuel and the second tank can contain a different kind of fuel. However, it is not required that the fuel tanks contain different kinds of fuel. Each fuel tank can hold various kind or grades of a liquid fuel. However, it is not required that the fuels tanks contain different grades of fuel. The fuel can be gasoline of various octane levels, kerosene, diesel fuel, aviation fuel, Avgas 100LL, etc. By “gasoline” it is meant a volatile mixture of flammable liquid hydrocarbons derived chiefly from crude petroleum and used as a fuel, a solvent, an illuminant, and a thinner. By “kerosene” it is meant a thin oil distilled from petroleum or shale oil, used as a fuel and a denaturant for alcohol. The fuel capacity of the fuel tank can vary. The fuel capacity of each fuel tank can range from about 50 gallons to about 20,000 gallons. Desirably, each fuel tank has a fuel capacity ranging from between about 100 gallons to about 1,000 gallons. More desirably, each fuel tank has a fuel capacity ranging from between about 150 gallons to about 700 gallons. Even more desirably, each fuel tank has a fuel capacity ranging from between about 200 gallons to about 600 gallons. Most desirably, each fuel tank has a fuel capacity of at least about 250 gallons. In certain embodiments, it is desirable that each fuel tank has a fuel capacity of no more than 119 gallons to avoid additional restrictions imposed by the U.S. Department of Transportation. Additional information regarding these DOT limitations and using fuel tanks with smaller capacities is provided in U.S. Pat. Nos. 10,099,915 and 10,280,067, each filed on Jun. 10, 2016, which are incorporated by reference herein.

The fuel tanks can be constructed with internal baffles which can limit or prevent the fuel sloshing or moving about as the non-fixed or mobile fuel platform is transported. However, it is not required that the fuel tanks are manifolded in this manner. The fuel tanks can also include one or more pressure relief valves, a lockable security fuel cap, a liquid level fuel gauge, and a drain plug, with or without a lockable drain pipe cover. Because the fuel tanks on the non-fixed or mobile fuel platform are designed to store a flammable liquid, it is recommended that a fire extinguisher be mounted on the non-fixed or mobile fuel platform. By “flammable” it is meant easily ignited and capable of burning rapidly. The non-fixed or mobile fuel platform further includes a first compartment. The first compartment is located at the front of the trailer. The first compartment can be made lockable, if desired. The first compartment has one or more doors. Two oppositely aligned and angled doors, are present on the non-fixed or mobile fuel platform. Each of the doors, can be mounted on a set of hinges, which will enable each of the doors, to move between a closed position, as depicted, and an open position. The first compartment can vary in size and shape. The first compartment should be large enough to house a number of needed components, such as a battery, a fuel pump, a “Weights & Measures” flow meter, a filter housing, fuel lines, etc. One or more of these components can be secured in place within the enclosure compartment.

The non-fixed or mobile fuel platform also includes a second compartment and a third compartment. The second compartment is located on the left side of the trailer when viewed from the rear, and the third compartment is located on the right side of the trailer when viewed from the rear. Alternatively, one could make one larger second compartment, if desired. However, the present of a second and a third compartments, and respectively, is advantageous in keeping certain components separated. The second compartment can be made lockable, if desired. The second compartment has a door. The door can be secured by a set of hinges which enable the door to move between a closed position, as depicted, and an open position. The door can move or swing away from the rear or back end of the non-fixed or mobile fuel platform. The second compartment can vary in size and shape. The second compartment should be large enough to house a number of needed components, such as a “Point of Sale” (POS) electronic hardware, and “Weights & Measures” electronics.

The third compartment is shown without a door. The third compartment can also vary in size and shape. The third compartment should be large enough to house a number of needed components, such as: a “Register & Pump” controller (not shown), a fuel hose, a hose reel, a fuel nozzle, and an anti-static grounding cable. Because the fuel hose has to be pull out of the fuel reel to dispense fuel to a vehicle, for example, a boat, an airplane, etc. and then be retracted back into the fuel reel, it does not make sense to obstruct the third compartment with a door. However, a door could be added, if needed.

The “Weights & Measures” hardware consists of various components used to keep track of the amount of fuel dispensed. Most states in the United States regulate the sale and distribution of fuel and require that the dispensing mechanisms used to do this be checked to make sure the general public is not being cheated. In addition, the states generate a substantial amount of tax dollars from the sale of fuel and they want to make sure they are getting their proper share. The “Weights & Measures” equipment is commercially available from several different suppliers. Several brands and models are listed below.

1. TCS Flow Meters, 682 and 700:

http://tcsmeters.com/index.php/en/applications/category/1/flowmeters.

Total Control Systems (TCS) has an office at 2515 Charleston Place, Fort Wayne, Ind. 46808

2. TCS Electronic Register Flow Controller:

http://tcsmeters.com/index.php/en/products/details/58/2/electronicregistration/tcs-3000-electronic-register

3. TCS Mechanical Register Flow Controller, 7887, 7888, 7889:

http://tcsmeters.com/index.php/en/products/category/11/mechanical-registration

4. TCS Flow Control Valves:

http://tcsmeters.com/index.php/en/products/details/48/6/component-accessories/control-valves/655-electronic-control-valve

5. TCS Air Eliminators, 740, 745, 748, 749:

http://tcsmeters.com/index.php/en/products/category/5/componentaccessories/air/vapor-elimination

6. Liquid Controls Flow Meters:

http://www.lcmeter.com/en/Products/productPages/PosDis.html. Liquid Controls has an office at 105 Albrecht Drive, Lake Bluff, Ill. 60044.

7. Liquid Controls Electronic Register Flow Controller:

http://www.lcmeter.com/en/Products/electronicProd/Electronics.html

8. Liquid Controls Mechanical Register Flow Controller:

http://www.lcmeter.com/en/Products/Accessories/Mechnical.html

9. Liquid Controls Flow Control Valves:

http://www.lcmeter.com/en/Products/electronicProd/Electronic_Valves.html

10. Liquid Controls Air Eliminators:

http://www.lcmeter.com/en/Products/electronicProd/Optical_Air_Eliminator.html

Examples of the fuel pump, meter, fuel nozzle, and filters that can be used non-fixed or mobile fuel platform include but are not limited to the followings:

1. Pumps: http://catalog.gpi.net/category/electric-pumps?plpver=1001

2. Meters: http://catalog.gpi.net/category/fuel-meters?plpver=1001

3. Nozzles: http://catalog.gpi.net/viewitems/accessories/nozzles?plpver=1001

4. Aviation Nozzles: http://www.opwglobal.com/products/us/retailfueling-products/above-ground-products/standard-dispensingequipment/manual-nozzles-aircraft-bulk-general-andaccessories/overwing-aircraft-nozzles/opw-295 a-saj-aircraftnozzles

5. Filters: http://catalog.gpi.net/viewitems/accessories/filters-filteradapter?plpver-1001

Examples of the fuel hose reel and grounding cable that can be used in the non-fixed or mobile fuel platform include but are not limited to the followings:

1. http://reelcraft.com/pdfs/catalogs/pages/cat13.pdf

2. http://reelcraft.com/pdfs/catalogs/pages/cat10.pdf

3. http://reelcraft.com/pdfs/catalogs/pages/cat18.pdf

4. http://www.hannay.com/productpage.asp?IDENT=129

5. http://www.hannay.com/productpage.asp?IDENT=124

6. http://www.hannay.com/productpage.asp?IDENT=125

Reelcraft Industries has an office at 2842 east Business Highway 30, Columbia City, Ind. 46725. Hannay Reels has an office at 553 State Route 143, Westerlo, N.Y. 12193-0159. Westech Equipment Company is an authorized distributor of Hannay Reels.

The fuel hose can be a Continental brand hose or similar hose having ¾″ to 3″ inside diameter ranging from between 0.75 of an inch to 3 inches. The fuel hose can vary in length. The length of the fuel hose can range from between about 8 feet to about 250 feet. Desirably, the length of the fuel hose ranges from between about 10 feet to about 150 feet. More desirably, the length of the fuel hose ranges from between about 15 feet to about 125 feet. Even more desirably, the length of the fuel hose ranges from between about 20 feet to about 100 feet. Most desirably, the length of the fuel hose is less than about 75 feet. The power source for the various components of the non-fixed or mobile fuel platform can vary. The power source can be an Interstate Deep Cycle Marine/RV Battery, 12 volts, direct current. A solar panel with a solar charge controller can be used to recharge the battery. A tow vehicle equipped with a 12 volt, direct current output when connected to the adapter. An external DC (direct current) battery charger plugged into an AC (alternating current) power connection. The AC power can be in the range of 110 volts to 240 volts. A fuel powered generator could also be used as the power source. These and other power sources known to those skilled in the art can also be used.

The second compartment is designed to retain a “Point of Sale” (POS) mechanism which will appear in the windows. The “Point of sale” system computer components can include one or more buttons, a touch screen, be voice activated, and/or use some other method for input control. Examples of input controls include but are not limited to: mobile handheld devices including cellular phones and mobile computers. Two currently used devices include: Panasonic Touchpad FZ-E1 that runs Windows embedded handheld Operating System, and Panasonic FZ-X1 that runs Android Operating System. See, http://business.panasonic.com/toughpad/us/5-inch-tablet-fzx1.html. Tablets and flat screen devices can also be used. Two currently used devices include: Panasonic FZ-M1 that runs Windows Operating System, and Panasonic FZ-B2 that runs Android Operating System. See, http://business.panasonic.com/toughpad/us/7-inch-tablet-fz-m1.html. A tower, desktop, compact, embedded, server, and other computer systems running Linux, Apache, Windows, Android, Apple, and other Operating Systems can also be used.

A person will be able to pay for the fuel that is dispensed from the non-fixed or mobile fuel platform by using one or more different payment methods. A slot is formed in the door to receive the various forms of payment. The slot can vary in size and shape to accommodate such payment. Payment could be made with a credit card, a debit card, a fleet card, a gift card, etc. The payment mechanism (not shown) could include a reader that accepts cards having a magnetic strip, an EMV chip, or a pin-based type card. The payment mechanism could also accept cash in the form of bills, coins, tokens, etc. The payment mechanism could also be built to receive wireless payment data through various hardware devices that accept Bluetooth, near field communication (NFC), etc. Bluetooth is a registered trademark of Bluetooth Sig, Inc. having an office at Suite 350, 5209 lake Washington Boulevard, Kirkland, Wash. 98033. The payment mechanism could also accept payment via Web page forms, kiosk page forms, paper forms, and electronic or email forms. The payment mechanism can utilize an input/output signal controller. For example, a LABJACK I/O signal controller could be used. LabJack has an office at 3232 South Vance Street, Lakewood, Colo. 80227. The signal controller could be designed to receive and/or send outputs, both analog and digital signals, to and from hardware implemented throughout the Petro2Go Mobile Fuel Island. Sensors for monitoring the fuel pressure, tank fuel level, tire air pressure, low printer paper, etc. could also be utilized. An emergency shut off button could be used to cut off power to the fuel pump when needed. The signal controller could further obtain and transfers data collection and send alerts back to the PC, and then send alerts to the BEMA interface. A printer receipt can be provided to the consumer via a window. The printer for providing the receipt could be identical to that currently used in gas stations throughout the United States.

The non-fixed or mobile fuel platform incorporates “Point of Sale” hardware. This hardware could include a Liquid Crystal Display (LCD) or touch screen LCD available on some Smart Phones, Tablets, or PC platforms. The “Point of Sale” hardware could also include a receipt printer, a credit card swipe, 4G cellular SIM card for data send/receive, WIFI for data send/receive, and a keyboard, pin pad, or both (Hardware or Software versions). The software needed to operate the “Point of Sale” hardware can be an interface to allow consumers to purchase fuel in a self-serve environment. The software can also be operated by an attendant/operator for fuel sales in commerce to consumers operating on a mobile platform.

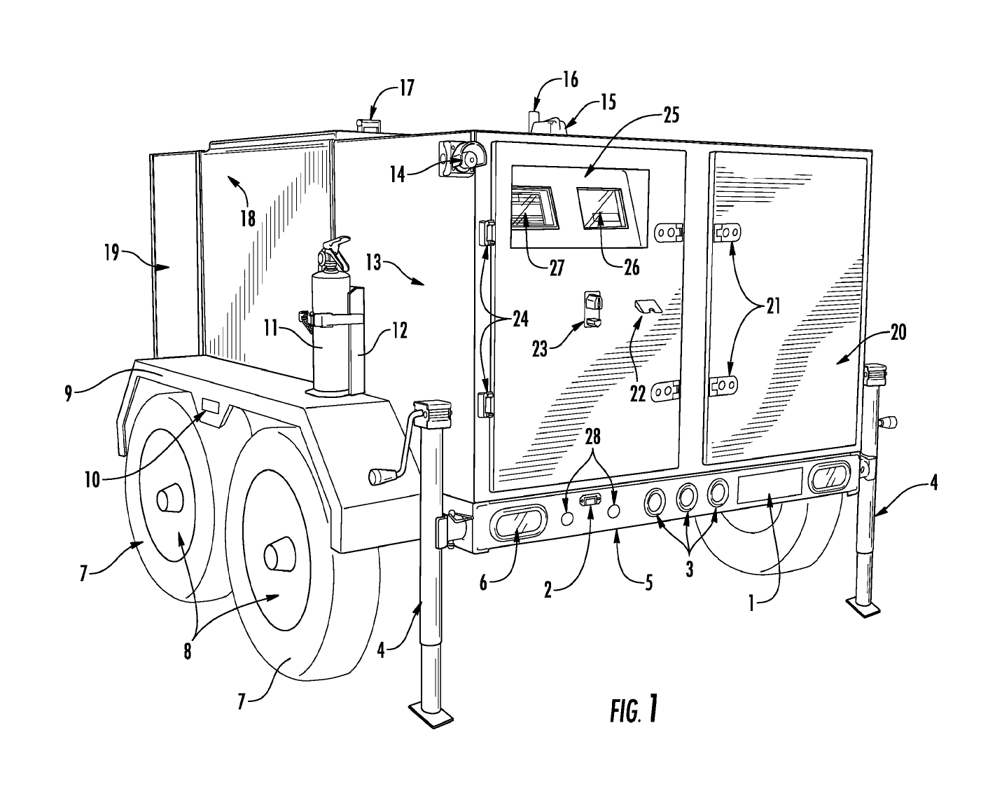

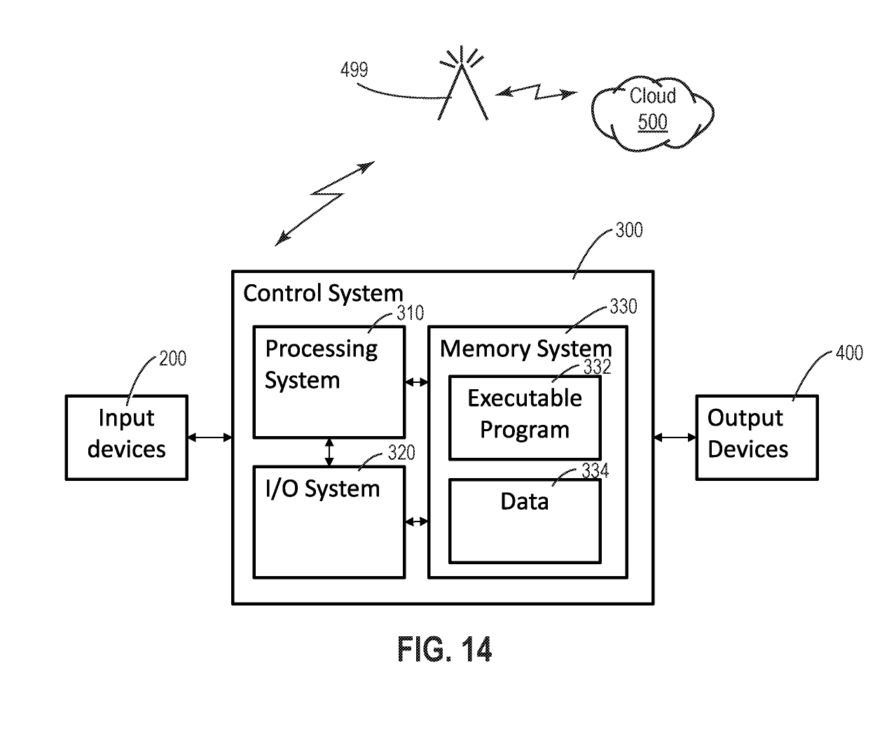

FIG. 14 shows an exemplary control system 300 for controlling a portable system for transporting, storing, and dispensing the liquid fuel previously discussed (such as shown in FIG. 1). Certain aspects of the present disclosure are described or depicted as functional and/or logical block components or processing steps, which may be performed by any number of hardware, software, and/or firmware components configured to perform the specified functions. For example, certain embodiments employ integrated circuit components, such as memory elements, digital signal processing elements, logic elements, look-up tables, or the like, configured to carry out a variety of functions under the control of one or more processors or other control devices. The connections between functional and logical block components are merely exemplary, which may be direct or indirect, and may follow alternate pathways.

The control system 300 may be a computing system that includes a processing system 310, memory system 330, and input/output (I/O) system 320 for communicating with other devices, such as input devices 200 and output devices 400. The processing system 310 loads and executes an executable program 332 from the memory system 330, accesses data 334 stored within the memory system 330, and directs the SYSTEM to operate as described in further detail below.

The processing system 310 may be implemented as a single microprocessor or other circuitry, or be distributed across multiple processing devices or sub-systems that cooperate to execute the executable program 332 from the memory system 330. Non-limiting examples of the processing system include general purpose central processing units, applications specific processors, and logic devices.

The memory system 330 may comprise any storage media readable by the processing system 310 and capable of storing the executable program 332 and/or data 334. The memory system 330 may be implemented as a single storage device, or be distributed across multiple storage devices or sub-systems that cooperate to store computer readable instructions, data structures, program modules, or other data. The memory system 330 may include volatile and/or non-volatile systems, and may include removable and/or non-removable media implemented in any method or technology for storage of information. The storage media may include non-transitory and/or transitory storage media, including random access memory, read only memory, magnetic discs, optical discs, flash memory, virtual memory, and non-virtual memory, magnetic storage devices, or any other medium which can be used to store information and be accessed by an instruction execution system, for example.

As shown in FIG. 14, the present disclosure further relates to a system for managing the sale of liquid fuel from one or more of the portable systems for transporting, storing, and dispensing the liquid fuel previously described. Communication is provided for the embodiment presently shown via a wireless connection between one or more portable systems (each having its own control system 300) and a cloud-based server 500, such as via a cellular tower 499 as previously discussed. Using this wireless communication, the cloud-based server 500 is configured to receive data regarding purchases of the liquid fuel made via the point of sale systems for each of the one or more portable systems.

In certain embodiments, the cloud-based server 500 allows for tracking and trending of purchased liquid fuel from a particular portable system, and/or from a particular user, over time. This may assist with management of the portable system in terms of refueling, cash removal, and/or servicing in general. Likewise, this information may be useful in determining demand within a particular region, which may inform decisions such as changing the capacity of portable system provided in a location, or the need to deploy greater or fewer portable systems within a vicinity, for example. Additional exemplary uses include managing of fuel usage for a fleet, tracked by the particular user purchasing the fuel from these portable systems, for example. In other embodiments, the cloud-based server 500 may additionally or alternatively serve as the payment source for purchases made at the individual portable systems. For example, the cloud-based server 500 may store a prepaid payment balance for a particular user (such as within the exemplary memory system 330 previously discussed). In this manner, a user can purchase the liquid fuel at any of the portable systems communicating with the cloud-based server 500 using funds stored thereon, without the need to carry cash, credit cards, or debit cards. This may help to reduce losses from lost or stolen cards, and/or non-fuel purchases made on conventional payment cards. This may also be further useful for tracking and managing vehicles within a fleet, or users operating these vehicles.

While the invention has been described in conjunction with several specific embodiments, it is to be understood that many alternatives, modifications and variations will be apparent to those skilled in the art in light of the foregoing description. Accordingly, this invention is intended to embrace all such alternatives, modifications and variations which fall within the spirit and scope of the appended claims.

What is claimed is:

1. A portable system for transporting, storing, and dispensing liquid fuel comprising:
two or more non-manifolded fuel tanks;
a pump dispensing system consisting of a fuel pump, a fuel hose, and a nozzle;
a portable platform consisting of a frame sufficient to support the weight of the entire system while the two or more non-manifolded fuel tanks are full of the liquid fuel;
a custody transfer flow meter; and
a point of sale system.

2. The system of claim 1, wherein the point of sale system comprises a mechanism for input control, a payment mechanism, and a display.

3. The system of claim 2, wherein the input control consists of at least one of mobile handheld device, cellular phone, mobile computer, keypad, keyboard, touch screen, key fob, barcode reader, biometric scanner, retina scanner, and microphone.

4. The system of claim 2, wherein the payment mechanism is a reader that accepts cards having at least one of magnetic strip, EMV chip, and pin-based card.

5. The system of claim 2, wherein the payment mechanism accepts cash in the form of at least one of bills, coins, and tokens.

6. The system of claim 2, wherein the payment mechanism accepts wireless payment data through hardware devices that accept at least one of Wi-Fi, Bluetooth, and near field communication (NFC).

7. The system of claim 2, wherein the payment mechanism accepts payment via at least one of web page form, kiosk page form, paper form, electronic form, and email form.

8. The system of claim 2, further comprising at least one of a receipt printer, a credit card reader, a cellular SIM card capable of at least one of data send and receive, a Wi-Fi device capable of at least one of data send and receive, a keyboard, a barcode reader, a hardware pin pad, and a software rendered pin pad.

9. The system of claim 2, wherein the display comprises at least one of a mobile phone, a tablet, a flat screen device, a television, a monitor, a touch screen, a three dimensional display, a liquid crystal display, and an image projection.

10. The system of claim 1, wherein the point of sale system allows the liquid fuel to be purchased in a self-serve environment.

11. The system of claim 1, wherein the point of sale system allows payment via a web portal.

12. The system of claim 1, wherein the point of sale system is connected to the custody-transfer flow meter and receives data on the amount of the liquid fuel dispensed.

13. The system of claim 12, wherein the data is further provided to a cloud-based server wirelessly connected to the system.

14. The system of claim 13, wherein the server stores payment information receivable by the point of sale system for purchasing the liquid fuel therefrom.

15. The system of claim 14, wherein the liquid fuel is purchased using prepaid funds recorded as the payment information stored on the cloud-based server.

16. The system of claim 1, wherein the two or more non-manifolded fuel tanks each have an individual capacity of no more than 119 gallons of the liquid fuel.

17. The system of claim 1, wherein the point of sale system is configured to accept identifying information of a user and invoices the user for the amount of the liquid fuel dispensed.

18. A system for managing the sale of liquid fuel, the system comprising:
one or more portable systems for transporting, storing, and dispensing the liquid fuel, each of the one or more portable systems comprising:
two or more non-manifolded fuel tanks;
a pump dispensing system consisting of a fuel pump, a fuel hose, and a nozzle;
a portable platform consisting of a frame sufficient to support the weight of the entire system while the two or more non-manifolded fuel tanks are full of the liquid fuel;
a custody transfer flow meter;
a wireless communication device; and
a point of sale system;
a cloud-based server configured to communicate with the one or more portable systems via the wireless communication device;
wherein the cloud-based server is configured to receive data regarding purchases of the liquid fuel made via the point of sale systems for each of the one or more portable systems.

19. The system of claim 18, wherein the cloud-based server is configured to store payment information receivable by the point of sale systems for purchasing the liquid fuel therefrom.

20. The system of claim 19, wherein system is configured such that the liquid fuel is purchasable using prepaid funds recorded as the payment information stored on the cloud-based server and receivable by the one or more portable systems.
